(19) United States
(12) Patent Application Publication
(10) Pub. No.: US 2025/0102792 A1
(43) Pub. Date: Mar. 27, 2025

(54) THERMALLY-DRIVEN FULL-OCEAN-DEPTH LENS WIPING DEVICE AND METHOD

(71) Applicant: ZHEJIANG LAB, Zhejiang (CN)

(72) Inventors: Yiming LIANG, Zhejiang (CN); Haoyuan DU, Zhejiang (CN); Keren XIE, Zhejiang (CN); Yanyan ZHANG, Zhejiang (CN); Chen QIAN, Zhejiang (CN); Yunhe BAI, Zhejiang (CN); Ji ZHANG, Zhejiang (CN); Jiakai ZHU, Zhejiang (CN)

(73) Assignee: ZHEJIANG LAB, Zhejiang (CN)

(21) Appl. No.: 18/973,068

(22) Filed: Dec. 8, 2024

Related U.S. Application Data
(63) Continuation of application No. PCT/CN2023/118346, filed on Sep. 12, 2023.

(30) Foreign Application Priority Data
Jun. 9, 2023 (CN) 202310681123.5

(51) Int. Cl. G02B 27/00; B08B 1/16; H04N 23/50

(52) U.S. Cl. CPC G02B 27/0006; B08B 1/16; H04N 23/50

(57) ABSTRACT

A thermally-driven full-ocean-depth lens wiping device and a method. The device includes a wiper hingedly mounted on a housing, a shape memory alloy wire mounted on the housing and configured to connect and drive the wiper to perform a wiping motion, and a fixing component configured to position and arrange the shape memory alloy wire, and further includes the housing mounted on a full-ocean-depth lens and a waterproof connector electrically connected to the shape memory alloy wire; in the method, the shape memory alloy wire is electrically heated to be extended and contracted, thereby pulling the wiper to rotate, and wiping of the lens is completed.

### CROSS-REFERENCE TO RELATED APPLICATION

This application is a continuation of international application of PCT application serial no. PCT/CN2023/118346, filed on Sep. 12, 2023, which claims the priority benefit of China application no. 202310681123.5, filed on Jun. 9, 2023. The entirety of each of the above-mentioned patent applications is hereby incorporated by reference herein and made a part of this specification.

### BACKGROUND

### Technical Field

The disclosure relates to an underwater lens cleaning device and method in the field of underwater equipment and smart materials, and particularly relates to a thermally-driven full-ocean-depth lens wiping device and method.

### Description of Related Art

The lens of a camera used outdoors for a long time is very likely to be clogged with dirt, which greatly affects the image quality. Therefore, cameras used outdoors are usually equipped with a lens wiping device. As exploration and research by humanity of the deep ocean deepen, the demand for underwater photography and observation is also increasing. However, during underwater shooting and observation, the lens is usually easily contaminated by factors such as seawater and seaweed, affecting the image quality and observation effect. In order to solve this problem, underwater lens wiping devices are widely used in the field of underwater photography and observation.

Cameras working underwater also need to be equipped with a lens wiping device to avoid the influence of mud, plant and animal debris, and other suspended stains to keep the lens clean. For underwater cameras, especially cameras in the deep sea, the working characteristics thereof determine that it is unrealistic to use regular manual wiping methods. Therefore, it is necessary to design relevant devices to regularly and automatically wipe and decontaminate the lens.

Flushing with water flow is not realistic underwater, especially in the deep sea, which poses a huge challenge to the size and weight of the equipment. Therefore, a driver-driven brush head is commonly used to clean the lens. The commonly used driver for driving the brush head is a rotary or linear motor, which usually also requires a corresponding transmission mechanism, and thereby the mass of the device may often reach several kilograms. In addition, although the corresponding technology is relatively mature, the technology also has shortcomings such as high price and pressure resistance difference, and the working depth is mostly tens to hundreds of meters. Therefore, with the continuous development of underwater detection technology, the demand for underwater full-ocean-depth lens is becoming more and more urgent.

### SUMMARY

In order to solve the problems of high cost, large volume and weight, and low working depth of the existing underwater lens wiping device, the disclosure designs a full-ocean-depth lens wiping structure and device using a shape memory alloy wire, the lens is cleaned regularly by using the shape memory alloy wire to directly drive the wiping rod, thereby the device is light in weight, low in energy consumption, and able to work at full ocean depth.

The technical solution adopted by the disclosure is:

### 1. A Thermally-Driven Full-Ocean-Depth Lens Wiping Device

The device includes a housing mounted on a full-ocean-depth lens, and the housing is disposed with a lens through hole exposing a lens surface of the full-ocean-depth lens.

A wiper is hingedly mounted on a housing and is configured to wipe a lens surface of the full-ocean-depth lens exposed from the housing.

A shape memory alloy wire is mounted on the housing and connected to the wiper to drive the wiper to perform a wiping motion.

A fixing component is configured to position and arrange the shape memory alloy wire.

A waterproof connector is electrically connected to the shape memory alloy wire.

The housing includes a front cover and a back cover. An inner cavity for securing the full-ocean-depth lens is formed between the front cover and the back cover.

Preferably, a threaded hole is disposed on the front cover, and the screw passes through a through hole of the back cover to be threadedly connected with the threaded hole, so that the front cover and the back cover are fixedly connected.

Preferably, the edge of a side of the front cover facing the back cover is disposed with 6 circumferentially distributed threaded holes for fixed connection with the back cover, at the same time, the edge of the end surface of the back cover is disposed with multiple circumferentially distributed threaded holes, and the multiple threaded holes are used for connection with the front cover.

The wiper includes a wiping rod and a wiping rubber strip, and a near-middle portion of the wiping rod and the front cover of the housing are hinged via a screw and a helical spring.

Preferably, the screw is a half-threaded screw, the half-threaded screw passes through the wiping rod and the helical spring and is connected to a threaded hole of the front cover, and the helical spring acts as a spring to control the return of the rotation of the wiping rod.

In a specific implementation, the helical spring is a flat spiral type helical spring, and the function of the helical spring is to adjust the distance between the wiping rod and the lens.

The return spring of the helical spring is located between the wiping rod and the half-threaded screw, and is configured to provide force for the recovery of the wiping rod. The shape memory alloy wire can provide pulling force when being energized, but cannot provide recovery thrust when being cooled down and returning to the original length thereof. When a larger wiping force is needed, the screw may be appropriately tightened to compress the spring a little more.

The swing amplitude range of the wiping rod of the wiper is just from the tangent point to a side of the circular lens surface of the full-ocean-depth lens to the tangent point to the other side of the circular lens surface of the full-ocean-depth lens.

The wiper and the shape memory alloy wire are both arranged on the front end surface of the housing. A lens through hole is disposed on the front end surface of the housing. The wiper is hinged on the front end surface of the housing around the periphery of the lens through hole, an end of the shape memory alloy wire is fixed to the front end surface of the housing on one side of a hinge section of the wiper, and the other end is fixed to the outer end of the wiper from the other side of the hinge section of the wiper after passing through an annular path around the periphery of the lens through hole.

The fixing component includes a buckle and a groove bearing. Two ends of the shape memory alloy wire are both fixedly connected to the front end surface of the housing and the outer end of the wiper through the buckle, bearing points are disposed at multiple locations on the annular path where the shape memory alloy wire passes through around the periphery of the lens through hole, the groove bearing hinged to the front end surface of the housing is arranged on the bearing point, and the shape memory alloy wire passes through around the outer side of the groove bearing.

Preferably, a plurality of circumferentially distributed threaded holes are disposed on the side of the front cover facing the lens for fixing the half-threaded screws, and the groove bearing matches with the half-threaded screw to provide guidance for the shape memory alloy wire, so that the shape memory alloy wire is arranged according to a fixed path.

Preferably, the buckle refers to an end of the shape memory alloy wire 7 being wound back and then fastened with a hoop.

An end of the waterproof connector is connected to the two ends of the shape memory alloy wire, and the other end is connected to a power source. The power source may be a battery or an external power supply end.

When the power source is a battery, the battery is placed in an inner cavity formed between the front cover and the back cover of the housing.

Preferably, the wire between the waterproof connector and the shape memory alloy wire passes through the front cover and the back cover of the housing. The front cover and the back cover are both disposed with wire through holes, and the wire through holes are used for laying out wires.

The end surface of the back cover is disposed with a water permeable hole for balancing the water pressure inside and outside the device.

The housing, the wiping rod of the wiper, the fixing component, etc. are all metal parts.

The shape memory alloy wire is externally wrapped with insulating material; and the internal power supply and other systems of the device need to be waterproofed.

The structure of the disclosure is simple but very effective, all components are pressure-resistant and have no closed cavity structure, and the full ocean depth refers to a depth of 11,000 meters.

The disclosure can significantly amplify the movement through the coordinated control of the wiper, the shape memory alloy wire, and the fixing component, and can quickly and effectively control the rotation of the wiping rod, thereby the wiping of the lens is completed.

### 2. A Full-Ocean-Depth Lens Wiping Method

The method is to electrically heat the shape memory alloy wire to be extended and contracted, thereby pulling the wiper to rotate, and the wiping of the lens is achieved.

When the shape memory alloy wire is energized, the temperature of the shape memory alloy wire increases and the length shortens, the wiping rod of the wiper overcomes the force of the helical spring and rotates, and the wiping rubber strip of the wiper passes through the surface of the lens to complete the wiping of the lens.

When the shape memory alloy wire is cut off from the electric current, the temperature of the shape memory alloy wire decreases and the length recovers, the wiping rod of the wiper gradually returns and rotates back to the original position thereof under the force of the helical spring, and the wiping rubber strip of the wiper passes through the surface of the lens again to complete the wiping of the lens.

The beneficial effects of the disclosure are as follows:
(1) In the disclosure, the shape memory characteristic of the shape memory alloy serves as the mechanism for contraction when heated, which does not require a special transmission mechanism, and has the advantages of simple driving method and low price.
(2) The shape memory alloy materials have high corrosion resistance and fatigue resistance, are suitable for harsh underwater environments, and can maintain stable working performance for a long time.
(3) When used underwater, the shape memory alloy wire does not need to be equipped with a pressure-resistant casing or other sealing and pressure-resistant devices, and only needs to be well insulated, which further simplifies the complexity and weight of the device. The working pressure covers the full ocean depth and has great application prospects.
(4) The driving method of the disclosure also has the advantages of low noise and small vibration, which can ensure that the device not disturb the underwater creatures being photographed during operation, thereby ensuring the completion of the camera shooting task.

In the disclosure, the shape memory alloy wire is electrically heated to be extended and contracted, thereby driving the wiping rod to rotate, and the wiping of the lens is completed. The disclosure has the advantages of full ocean depth, low price, low noise, and high reliability.

The structure of the disclosure can easily realize underwater lens wiping, does not require bulky components such as motors, all parts are deep-sea components, the structure is simple and reliable, and can realize lens wiping work at a depth of 11,000 meters.

### BRIEF DESCRIPTION OF THE DRAWINGS

In order to more clearly describe the technical solution and content of the disclosure, the drawings required in the embodiments are briefly introduced below.

FIG. 1 is an axonometric view 1 of Embodiment 1 of the disclosure.

FIG. 2 is a partial enlarged view of Embodiment 1 of the disclosure.

FIG. 3 is an axonometric view 2 of Embodiment 1 of the disclosure.

FIG. 4A is a front view of a front cover and a back cover of Embodiment 1 of the disclosure.

FIG. 4B is a cross-sectional view of a front cover and a back cover of Embodiment 1 of the disclosure.

FIG. 5 is a view of the effect of mounting Embodiment 1 of the disclosure on an underwater lens.

FIG. 6 is a view of an initial working state of Embodiment 1 of the disclosure.

FIG. 7 is a view showing an ended working state of Embodiment 1 of the disclosure.

FIG. 8 is a side view of a state of Embodiment 1 of the disclosure.

### DESCRIPTION OF THE EMBODIMENTS

The technical solution proposed by the disclosure will be clearly and completely described below together with the accompanying drawings.

In the specific implementation of the disclosure, a wiping structure for wiping a full-ocean-depth lens 12 is first provided, which includes the following:

A wiper is hingedly mounted on a housing and is configured to wipe a lens surface of the full-ocean-depth lens 12 exposed from the housing.

A shape memory alloy wire 7 is mounted on the housing and connected to the wiper to drive the wiper to perform a wiping motion.

A fixing component is configured to position and arrange the shape memory alloy wire 7 according to a preset path.

The wiper includes a wiping rod 3 and a wiping rubber strip 6. The wiping rod 3 is radially arranged with respect to a lens through hole. A near-middle portion of the wiping rod 3 and a front cover 1 of the housing are hinged via a screw and a helical spring 9. The screw is a half-threaded screw 10, the half-threaded screw 10 passes through the wiping rod 3 and the helical spring 9 and is connected to a threaded hole 1-3 of the front cover 1, and the helical spring 9 acts as a return spring to control the return of the rotation of the wiping rod 3.

The wiper and the shape memory alloy wire 7 are arranged on the front end surface of the housing front cover 1. The front end surface of the housing front cover 1 is disposed with a lens through hole. The wiper is hinged on the front end surface of the housing front cover 1 around the lens through hole, an end of the shape memory alloy wire 7 is fixed to the front end surface of the housing front cover 1 on one side of a hinge section of the wiper, and the other end is fixed to a radial outer end of the wiping rod 3 of the wiper from the other side of the hinge section of the wiper after passing through an annular path around a periphery of the lens through hole, and the inner end of the wiper is configured to wipe the lens surface of the full-ocean-depth lens 12.

The fixing component includes a buckle 2, a half-threaded screw 4, and a groove bearing 5. Two ends of the shape memory alloy wire 7 are both fixedly connected to the front end surface of the front cover 1 of the housing and the outer end of the wiping rod 3 of the wiper through the buckle 2, bearing points are disposed at multiple locations on the annular path where the shape memory alloy wire 7 passes through around a periphery of the lens through hole, and the groove bearing 5 hinged to the front end surface of the front cover 1 of the housing is arranged on the bearing point. Specifically, the groove bearing 5 is fixed to the front end surface of the housing front cover 1 by the half-threaded screw 4. The shape memory alloy wire 7 passes through around the outer side of the groove bearing 5, so that the annular path arrangement located at the periphery of the wiper is formed between the two ends of the shape memory alloy wire 7 as a whole.

A plurality of circumferentially distributed threaded holes are disposed on the side of the front cover 1 facing the lens for fixing the half-threaded screws 4, and the groove bearing 5 matches with the half-threaded screw 4 to provide guidance for the shape memory alloy wire 7, so that the shape memory alloy wire 7 is arranged according to a fixed path.

As shown in FIG. 2, the buckle 2 refers to an end of the shape memory alloy wire 7 being wound back and then fastened with a hoop, which plays the role of fastening the end of shape memory alloy wire 7.

The shape memory alloy wire 7 adopts a single shape memory alloy wire or a plurality of shape memory alloy wires connected in parallel.

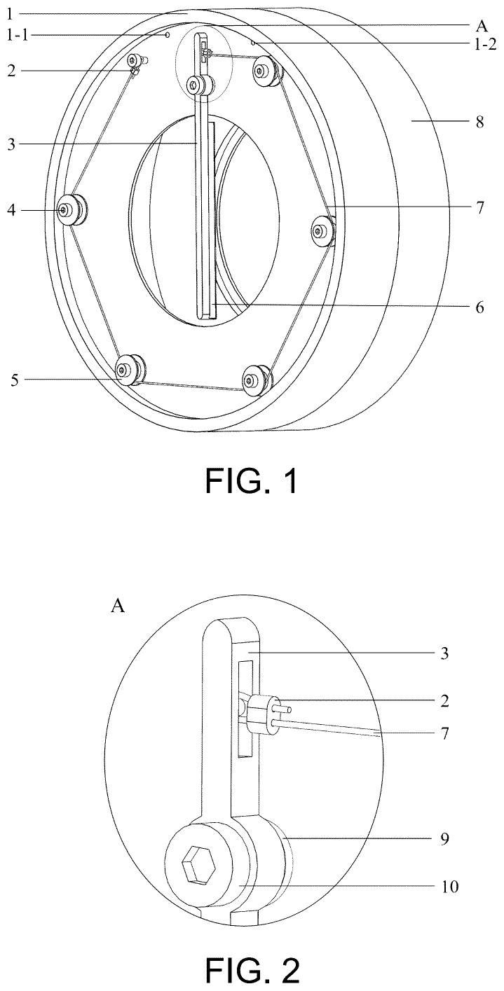

As shown in FIG. 1, the wiping structure of the disclosure is applied to the lens to form a complete wiping device, which specifically includes:

The housing is mounted on the full-ocean-depth lens 12, and the housing is disposed with a lens through hole exposing a lens surface of the full-ocean-depth lens 12.

A wiper is hingedly mounted on the housing and configured to wipe the lens surface of the full-ocean-depth lens 12 exposed from the housing.

The shape memory alloy wire 7 is mounted on the housing and connected to the wiper to drive the wiper to perform the wiping motion.

A fixing component is configured to position and arrange the shape memory alloy wire 7 according to a preset path.

A waterproof connector 11 is electrically connected to the shape memory alloy wire 7.

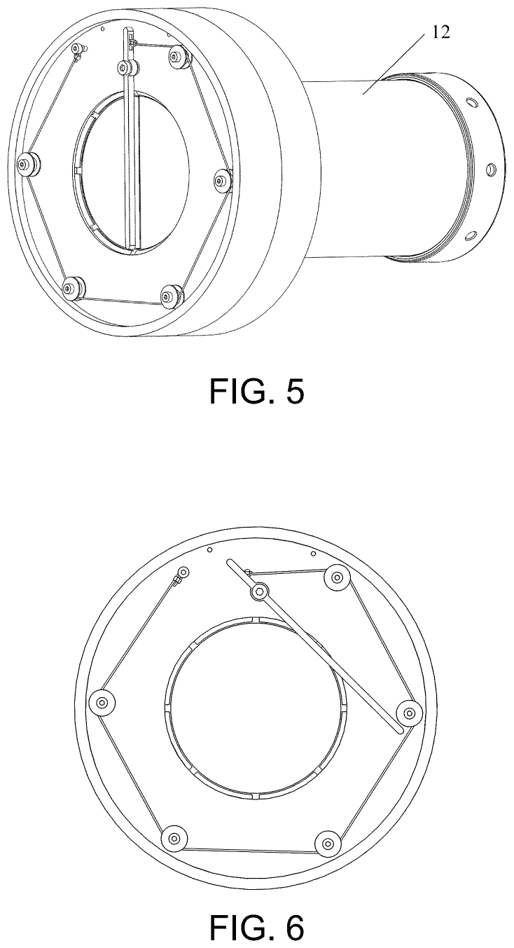

The housing includes a front cover 1 and a back cover 8. An inner cavity for securing the full-ocean-depth lens 12 is formed between the front cover 1 and the back cover 8. The head of the full-ocean-depth lens 12 is secured on the back cover 8. As shown in FIG. 5, the head of the full-ocean-depth lens 12 generally has an annular groove, the back cover 8 has a central through hole, and the central through hole is just embedded in the annular groove so that the full-ocean-depth lens 12 is secured.

In a specific implementation, a threaded hole 1-4 is disposed on the front cover 1, and the screw passes through a through hole 8-1 of the back cover 8 to be threadedly connected with the threaded hole 1-4, so that the front cover 1 and the back cover 8 are fixedly connected.

The edge of a side of the front cover 1 facing the back cover 8 is disposed with 6 circumferentially distributed threaded holes 1-4 for fixed connection with the back cover 8, at the same time, the edge of the end surface of the back cover 8 is disposed with multiple circumferentially distributed threaded holes 8-1, and the multiple threaded holes 8-1 are used for connection with the front cover 1.

As shown in FIG. 1, the wiper includes a wiping rod 3 and the wiping rubber strip 6. The wiping rod 3 is radially arranged with respect to the lens through hole. A near-middle portion of the wiping rod 3 and the front cover 1 of the housing are hinged via a screw and a helical spring 9. The screw is a half-threaded screw 10, the half-threaded screw 10 passes through the wiping rod 3 and the helical spring 9 and is connected to a threaded hole 1-3 of the front cover 1, and the helical spring 9 acts as a spring to control the return of the rotation of the wiping rod 3.

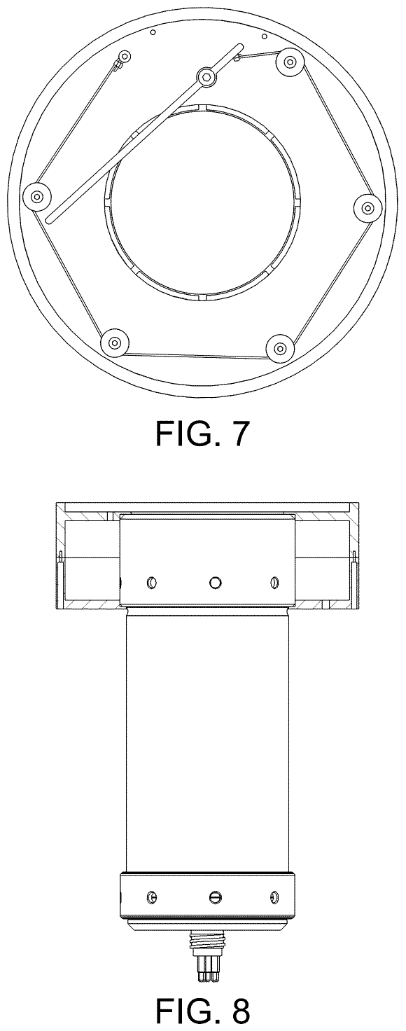

As shown in FIG. 6 and FIG. 7, the swing amplitude range of the wiping rod 3 of the wiper is just from the tangent point to a side of the circular lens surface of the full-ocean-depth lens 12 to the tangent point to the other side of the circular lens surface of the full-ocean-depth lens 12.

As shown in FIG. 1, the wiper and the shape memory alloy wire 7 are both arranged on the front end surface of the housing front cover 1. The lens through hole is disposed on the front end surface of the front cover 1 of the housing. The wiper is hinged on the front end surface of the front cover 1 of the housing around the periphery of the lens through hole, an end of the shape memory alloy wire 7 is fixed to the front end surface of the front cover 1 of the housing on one of the sides of the hinge section of the wiper, and the other end is fixed to the radial outer end of the wiping rod 3 of the wiper from the other side of the hinge section of the wiper after passing through the annular path around the periphery of the lens through hole, and the inner end of the wiper is configured to wipe the lens surface of the full-ocean-depth lens 12.

As shown in FIG. 1 and FIG. 4A, the fixing component includes the buckle 2, the half-threaded screw 4, and the groove bearing 5. The two ends of the shape memory alloy wire 7 are both fixedly connected to the front end surface of the housing front cover 1 and the outer end of the wiping rod 3 of the wiper through the buckle 2, the bearing points are disposed at multiple locations on the annular path where the shape memory alloy wire 7 passes through around the periphery of the lens through hole, and the groove bearing 5 hinged to the front end surface of the housing front cover 1 is arranged on the bearing point. Specifically, the groove bearing 5 is fixed to the front end surface of the housing front cover 1 by the half-threaded screw 4. The shape memory alloy wire 7 passes through around the outer side of the groove bearing 5, so that the annular path arrangement located at the periphery of the wiper is formed between the two ends of the shape memory alloy wire 7 as a whole.

A plurality of circumferentially distributed threaded holes are disposed on the side of the front cover 1 facing the lens for fixing the half-thread bolts 4, and the groove bearing 5 matches with the half-thread bolts 4 to provide guidance for the shape memory alloy wire 7, so that the shape memory alloy wire 7 is arranged according to a fixed path.

As shown in FIG. 2, the buckle 2 refers to the end of the shape memory alloy wire 7 wound back and then fastened with the hoop.

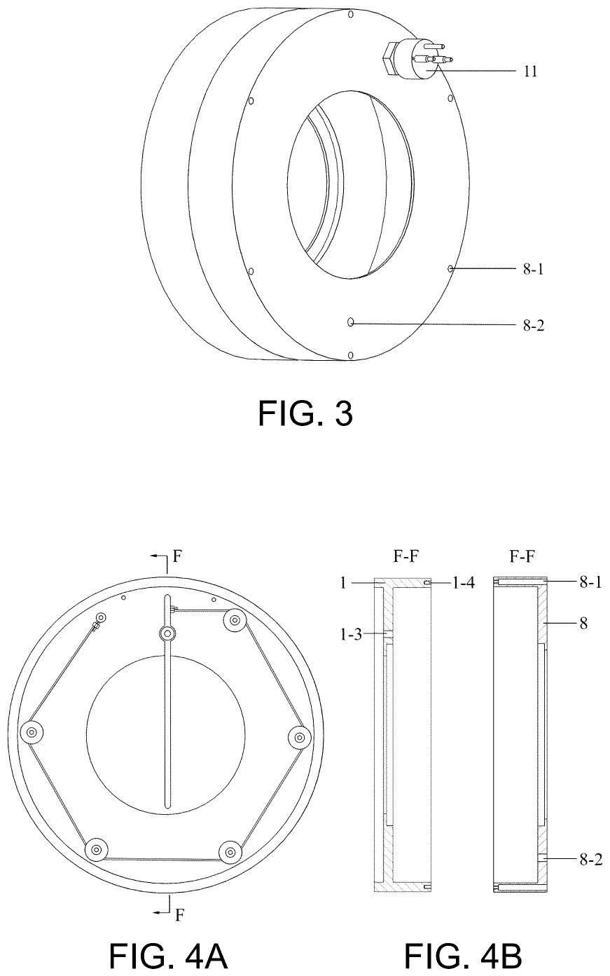

When the power supply is supplied by external wires, the waterproof connector 11 needs to be arranged on the back cover 8. As shown in FIG. 3, an end of the waterproof connector 11 is connected to the two ends of the shape memory alloy wire 7, and the other end is connected to the power source.

When the power source is a battery, the battery is placed in the inner cavity formed between the front cover 1 and the back cover 8 of the housing. In this case, the battery power source does not require the waterproof connector.

The wire between the waterproof connector 11 and the shape memory alloy wire 7 passes through the front cover 1 and the back cover 8 of the housing. The front cover 1 and the back cover 8 are both disposed with wire through holes 1-1 and 1-2, and the wire through holes 1-1 and 1-2 are used for laying out wires.

As shown in FIG. 4B, the end surface of the back cover 8 is disposed with a water permeable hole 8-2 for balancing the water pressure inside and outside the device, and the inner cavity of the housing is directly connected to the external seawater environment through the water permeable hole 8-2.

The housing, the wiping rod 3 of the wiper, the fixing component, and the helical spring 9 are all metal parts, specifically made of lightweight corrosion-resistant materials such as titanium alloy or aluminum alloy.

The shape memory alloy wire 7 is externally wrapped with insulating material; and the internal power supply and other systems of the device need to be waterproofed.

In practical applications, the wiping method is to electrically heat the shape memory alloy wire 7 to be extended and contracted, thereby pulling the wiping rod 3 of the wiper to rotate, and the wiping of the lens is achieved.

When the shape memory alloy wire 7 is energized, the temperature of the shape memory alloy wire 7 increases and the length of the shape memory alloy wire 7 shortens, the wiping rod 3 of the wiper overcomes the force of the helical spring 9 and starts to rotate from the original position, and the wiping rubber strip 6 of the wiper passes through the surface of the lens to complete the first wiping of the lens.

When the shape memory alloy wire 7 is cut off from the electric current, the temperature of the shape memory alloy wire 7 decreases and the length recovers, the wiping rod 3 of the wiper gradually returns and rotates back to the original position thereof under the force of the helical spring 9, and the wiping rubber strip 6 of the wiper passes through the surface of the lens again to complete the second wiping of the lens.

### Embodiment 1

As shown in FIG. 1 to FIG. 7, the lens wiping device of this embodiment includes the front cover 1, the buckle 2, the wiping rod 3, the half-threaded screw 4, the groove bearing 5, the wiping rubber strip 6, the shape memory alloy wire 7, the back cover 8, the helical spring 9, the half-threaded screw 10, and the waterproof connector 11.

Six circumferentially distributed threaded holes are disposed on the front panel of the front cover 1 (the side facing the wiper), through which the half-threaded screws 4 are fixed on the front cover 1, in which five half-threaded screws 4 are matched with the groove bearings 5; the groove bearing 5 plays a guiding role for the shape memory alloy wire 7; an end of the shape memory alloy wire 7 is connected to the half-threaded screw 4 by the buckle 2; the other end of the shape memory alloy wire 7 is connected to the wiping rod 3 through the buckle 2; it should be ensured that the contraction amount (4% to 5%) of the shape memory alloy wire 7 when heated can satisfy the complete wiping process of the lens.

The diameter of the shape memory alloy wire 7 is preferably in a range of 0.2 mm to 0.5 mm.

The front cover 1 is disposed with the through holes 1-1 and 1-2 for the wires to pass through.

The front cover 1 is disposed with the threaded hole 1-3 matching with the half-threaded screw 10; the helical spring 9 is mounted between the wiping rod 3 and the front cover 1 to provide a recovering force for the wiping rod to return.

Several circumferentially distributed threaded holes 1-4 are disposed on the back side of the front cover 1, preferably six in quantity; the back cover 8 is disposed with circumferentially distributed threaded holes 8-1, which are the same in quantity as the threaded holes 1-4, on the back side thereof, and are configured to match with the threaded holes 1-4 of the front cover 1; the sizes of the front cover 1 and the back cover 8 need to be determined according to the lens data. Preferably, when the front cover 1 is connected to the back cover 8, the covers can just secure the part of the lens protective housing protruding from the lens to play a fixing role.

The back side of the back cover 8 is disposed with the water permeable hole 8-2 for balancing the water pressure inside and outside the device; the back cover 8 further is further disposed with a threaded hole to match with the waterproof connector 11 to complete the power supply to the system, in which two wires pass through the through holes 1-1 and 1-2 respectively to connect to the two ends of the shape memory alloy wire 7 for power supply.

The wiping rubber strip 6 is fixed to the wiping rod 3 by super glue.

The front cover 1, the buckle 2, the wiping rod 3, and the ack cover 8 are preferably made of titanium alloy material; the half-threaded screw 4 and the half-threaded screw 10 are preferably made of aluminum alloy material; the groove bearing 5 and the helical spring 9 are preferably made of stainless steel; the shape memory alloy wire 7 is made of nickel-titanium alloy material, and the surface is coated with insulating material, which needs to have certain elasticity and high temperature resistance (not less than 120° C.), preferably polytetrafluoroethylene or silicone rubber; and the wiping rubber strip 6 is preferably made of rubber.

After the mounting of Embodiment 1 of the disclosure is completed, the contact pressure between the wiping rubber strip 6 and the lens 12 is adjusted by adjusting the half-threaded screw 10; the wiping rod 3 is adjusted to an initial working position and the access length of the shape memory alloy wire 7 is adjusted through the buckle 2 to ensure that the shape memory alloy wire 7 does not fall off from the groove bearing 5 during the working process; the two ends of the shape memory alloy wire 7 are connected to the wires for electric heating (taking the shape memory alloy wire with a wire diameter of 0.5 mm as an example, the current is preferably 2.5 A to 3 A).

When the shape memory alloy wire 7 is heated to the phase transition temperature, the shape memory alloy wire 7 contracts, and thereby pulling the wiping rod 3 to swing from the initial working position. When the shape memory alloy wire 7 contracts to the shortest, the wiping rod 3 reaches the ended working state, completing a wiping process.

Then, heating of the shape memory alloy wire 7 is stopped, the shape memory alloy wire 7 gradually cools down under the action of the surrounding seawater and gradually recovers to the original length thereof. At the same time, the wiping rod 3 also returns to the initial working state under the action of the helical spring 9, and the second wiping of the lens is completed during the recovery process.

If a single shape memory alloy wire is not enough to drive the wiping rod during implementation, multiple shape memory alloy wires may be connected in parallel to ensure that sufficient force can be provided.

The exterior of the power supply and the control system of Embodiment 1 needs to be waterproofed.

### Embodiment 2

In this embodiment, the structure is similar to Embodiment 1, except that a polymer lithium battery is used for power supply, and the battery is placed in the middle area formed by the front cover 1, the back cover 8, and the underwater camera 12, and the battery and the corresponding control system and the plug part are all waterproofed. In this embodiment, the waterproof connector 11 is no longer required.

What is claimed is:

1. A thermally-driven full-ocean-depth lens wiping device, comprising:
a housing mounted on a full-ocean-depth lens, wherein the housing is disposed with a lens through hole exposing a lens surface of the full-ocean-depth lens;
a wiper hingedly mounted on the housing and configured to wipe the lens surface of the full-ocean-depth lens exposed from the housing;
a shape memory alloy wire mounted on the housing and connected to the wiper to drive the wiper to perform a wiping motion;
a fixing component configured to position and arrange the shape memory alloy wire; and
a waterproof connector electrically connected to the shape memory alloy wire.

2. The thermally-driven full-ocean-depth lens wiping device according to claim 1, wherein the housing comprises a front cover and a back cover, and an inner cavity for securing the full-ocean-depth lens is formed between the front cover and the back cover.

3. The thermally-driven full-ocean-depth lens wiping device according to claim 1, wherein the wiper comprises a wiping rod and a wiping rubber strip, and a middle portion of the wiping rod and a front cover of the housing are hinged via a screw and a helical spring.

4. The thermally-driven full-ocean-depth lens wiping device according to claim 1, wherein the wiper and the shape memory alloy wire are both arranged on a front end surface of the housing, the front end surface of the housing is disposed with the lens through hole, the wiper is hinged on the front end surface of the housing around the lens through hole, an end of the shape memory alloy wire is fixed to the front end surface of the housing on one side of a hinge section of the wiper, and an other end is fixed to an outer end of the wiper from an other side of the hinge section of the wiper after passing through an annular path around a periphery of the lens through hole.

5. The thermally-driven full-ocean-depth lens wiping device according to claim 1, wherein the fixing component comprises a buckle and a groove bearing, two ends of the shape memory alloy wire are both fixedly connected to a front end surface of the housing and an outer end of the wiper respectively through the buckle, bearing points are disposed at a plurality of locations on an annular path where the shape memory alloy wire passes through around a periphery of the lens through hole, the groove bearing hinged to the front end surface of the housing is arranged on each of the bearing point, and the shape memory alloy wire passes through the periphery of the groove bearing.

6. The thermally-driven full-ocean-depth lens wiping device according to claim 1, wherein an end of the waterproof connector is connected to two ends of the shape memory alloy wire, an other end is connected to a power source, and the power source is a battery or an external power supply end.

7. The thermally-driven full-ocean-depth lens wiping device according to claim 1, wherein in response to a power source being a battery, the battery is placed in an inner cavity formed between a front cover and a back cover of the housing.

8. The thermally-driven full-ocean-depth lens wiping device according to claim 1, wherein the housing, a wiping rod of the wiper, and the fixing component are all metal parts.

9. A full-ocean-depth lens wiping method applied to the thermally-driven full-ocean-depth lens wiping device according to claim 1, wherein the method is to electrically heat the shape memory alloy wire to be extended and contracted, thereby pulling the wiper to rotate, and wiping of the full-ocean-depth lens is implemented.

10. The full-ocean-depth lens wiping method according to claim 9, wherein in response to the shape memory alloy wire being energized, a temperature of the shape memory alloy wire increases and a length thereof shortens, a wiping rod of the wiper overcomes a force of a helical spring and rotates, and a wiping rubber strip of the wiper passes through a surface of the full-ocean-depth lens to complete wiping of the full-ocean-depth lens,
in response to the shape memory alloy wire being cut off from an electric current, the temperature of the shape memory alloy wire decreases and the length thereof recovers, the wiping rod of the wiper gradually rotates back to an original position under the force of the helical spring, and the wiping rubber strip of the wiper passes through the surface of the full-ocean-depth lens again to complete wiping of the full-ocean-depth lens.
